(19) United States
(12) Patent Application Publication
(10) Pub. No.: US 2014/0069644 A1
(43) Pub. Date: Mar. 13, 2014

(54) Wellbore Servicing Compositions and Methods of Making and Using Same

(71) Applicants: B. Raghava REDDY, The Woodlands, TX (US); Jeremy HOLTSCLAW, Kingwood, TX (US); James William OGLE, Spring, TX (US); Jimmie WEAVER, Duncan, OK (US); Rajesh Kumar SAINI, Cypress, TX (US); Aaron BEUTERBAUGH, Spring, TX (US); Michael Wayne SANDERS, Houston, TX (US)

(72) Inventors: B. Raghava REDDY, The Woodlands, TX (US); Jeremy HOLTSCLAW, Kingwood, TX (US); James William OGLE, Spring, TX (US); Jimmie WEAVER, Duncan, OK (US); Rajesh Kumar SAINI, Cypress, TX (US); Aaron BEUTERBAUGH, Spring, TX (US); Michael Wayne SANDERS, Houston, TX (US)

(73) Assignee: HALLIBURTON ENERGY SERVICES, INC., Houston, TX (US)

(21) Appl. No.: 13/614,994

(22) Filed: Sep. 13, 2012

(51) Int. Cl. C09K 8/00; E21B 43/00; E21B 43/02

(52) U.S. Cl. CPC C09K 8/00; E21B 43/02; E21B 43/00
USPC 166/278; 507/244; 507/234; 166/305.1

(57) ABSTRACT

A method of servicing a wellbore in a subterranean formation comprising preparing a wellbore servicing fluid comprising a snake-in-cage composition; and placing the wellbore servicing fluid into a wellbore wherein the snake dissociates from the cage and enters one or more permeable zones within the wellbore. A wellbore treatment composition comprising a snake disposed within a cage wherein the cage comprises a crosslinked polymer.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field

This disclosure relates to methods of servicing a wellbore. More specifically, it relates to methods of servicing a wellbore with snake-in-cage compositions.

2. Background

Natural resources such as gas, oil, and water residing in a subterranean formation or zone are usually recovered by drilling a wellbore down to the subterranean formation while circulating a drilling fluid in the wellbore. After terminating the circulation of the drilling fluid, a string of pipe, e.g., casing, is run in the wellbore. The drilling fluid is then usually circulated downward through the interior of the pipe and upward through the annulus, which is located between the exterior of the pipe and the walls of the wellbore. Next, primary cementing is typically performed whereby a cement slurry is placed in the annulus and permitted to set into a hard mass (i.e., sheath) to thereby attach the string of pipe to the walls of the wellbore and seal the annulus. Subsequent secondary cementing operations may also be performed.

Oil or gas residing in the subterranean formation may be recovered by driving the fluid into the well using, for example, a pressure gradient that exists between the formation and the wellbore, the force of gravity, displacement of the fluid using a pump or the force of another fluid injected into the well or an adjacent well. The production of the fluid in the formation may be increased by hydraulically fracturing the formation. That is, a viscous fracturing fluid may be pumped down the wellbore to the formation at a rate and a pressure sufficient to form fractures that extend into the formation, providing additional pathways through which the oil or gas can flow to the well. Unfortunately, water rather than oil or gas may eventually be produced by the formation through the fractures therein. To provide for the production of more oil or gas, a fracturing fluid may again be pumped into the formation to form additional fractures therein. However, the previously used fractures first must be plugged to prevent the loss of the fracturing fluid into the formation via those fractures.

In addition to the fracturing fluid, other fluids used in servicing a wellbore may also be lost to the subterranean formation while circulating the fluids in the wellbore or otherwise placing fluids in the wellbore. In particular, the fluids may enter and be “lost” to the subterranean formation via depleted zones, zones of relatively low pressure, lost circulation zones having naturally occurring fractures, weak zones having fracture gradients exceeded by the hydrostatic pressure of the drilling fluid, and so forth. Such zones of high fluid intake are often referred to as “thief zones.” As a result, the service provided by such fluid is more difficult to achieve. For example, a drilling fluid may be lost to the formation, resulting in the circulation of the fluid in the wellbore being terminated and/or too low to allow for further drilling of the wellbore. Such conditions may be referred to as partial or complete loss of circulation or lost circulation.

In situations where a wellbore servicing fluid (WSF) is pumped into a formation that has a high rock matrix permeability, the fluid may not be completely lost as described above but nevertheless, a portion of the WSF may enter the zone leaving a concentrated fluid in the wellbore. This can also negatively influence the intended wellbore service. For example, when a carrier fluid is lost as filtrate from a sand-laden fracturing fluid or a gravel pack fluid, the particulate material may deposit unevenly in the fractures or in the annulus. In the case of fracturing fluids, the targeted fracture length may be compromised when sufficient fluid is not available. In the case of other wellbore servicing operations such as acid stimulation, the fluid may enter high permeability zones instead of the intended stimulation of low permeability zones. In case of secondary or tertiary oil recovery operations, the fluid intended to sweep the oil contained in the low permeability zones may bypass such zones by fluid loss to high permeability zones.

There are also many situations wherein a controlled release of chemicals as and when needed during a wellbore service operation is highly desirable. Currently, all the components of a treatment are typically added to the WSF on the surface and all the chemical components are free to interact with each other because they are not designed to be released to the fluid in a controlled manner, for example as a function of temperature, time or pH or other stimuli. While encapsulation of some chemicals is occasionally employed for controlled release of chemicals, for example oxidative breakers in fracturing fluids, such materials are expensive to manufacture, and require multiple formulations and products to meet the variety of wellbore conditions, for example wide temperature ranges and salinities and the like that exist in the geological formations.

An ongoing need exists for compositions and methods for adjusting the permeability of the formation and for controlled release of chemicals to facilitate wellbore servicing operations.

### SUMMARY

Disclosed herein is a method of servicing a wellbore in a subterranean formation comprising preparing a wellbore servicing fluid comprising a snake-in-cage composition; and placing the wellbore servicing fluid into a wellbore wherein the snake dissociates from the cage and enters one or more permeable zones within the wellbore.

Also disclosed herein is a wellbore treatment composition comprising a snake disposed within a cage wherein the cage comprises a crosslinked polymer.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1a and 1b are graphical representations of snake-in-cage networks and interpenetrating polymer networks.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

Disclosed herein are wellbore servicing compositions comprising a material effective as a carrier and a material effective as a cargo. The carrier and/or cargo materials may comprise one or more compounds, compositions, or combinations thereof. In an embodiment, the carrier comprises a material capable of engulfing, embedding, confining, surrounding, encompassing, enveloping, or otherwise retaining the cargo such that the carrier and cargo are transported downhole as a single material. A cargo is a material that is carried or otherwise transported by the carrier material. In an embodiment, the carrier is a gelled or gelatinous material and the cargo may be dispersed throughout the material, contained within a portion of the material, at least partially entangled or entwined with the carrier material on a molecular level, or otherwise molecularly associated with the carrier material such that the cargo and carrier are transported downhole about concurrently. Further it is to be understood that the carrier confines the cargo to the extent necessary to facilitate the about concurrent transport of both materials into the wellbore and further that within the wellbore the carrier and cargo are located molecularly proximate to each other. In an embodiment, the carrier entraps the cargo. For example, in the current disclosure, the cargo may be disposed within the carrier such that the entirety of the dimensions of the cargo lies at least partially molecularly dispersed within the dimensions of the carrier. Alternatively at least a portion of the cargo is disposed within one or more internal spaces of the carrier. Alternatively, the cargo replaces some portion of the material typically found within the carrier. In an embodiment, the cargo is dispersed throughout the carrier and the carrier and cargo form a composite material. In some embodiments, the carrier forms a discrete structure such that both the internal and external dimensions of the carrier are known. In such an embodiment the cargo when placed downhole may be said to be limited to the confines dictated by the external or internal dimensions of the carrier.

In an embodiment, the cargo may be distinguished from the carrier based on the relative mobility of each material. For example, the carrier may be considered stationary when compared to the cargo. In an embodiment, when the carrier and associated cargo are placed into a wellbore, then at least a portion of the carrier may adhere, adsorb, or otherwise become reversibly affixed to one or more surfaces of the formation with which it encounters. In an embodiment, portions of the carrier (optionally having cargo further associated therewith) are removed or separated from the WSF via contact with one or more surfaces, e.g., by adsorption on wellbore and/or formation surfaces, or by filtration of a portion of the treatment fluid (often referred to as ‘spurt loss’) thereby forming a coating or cake. Accordingly, the carrier (while still having cargo disposed therein) may become static in the wellbore and/or formation. In an embodiment, the deposition of the carrier (optionally having the cargo further associated therewith) may reduce fluid loss of the treatment fluid into the formation. In contrast, the cargo associated with the carrier may remain mobile when placed into a wellbore and restricted only by the confines imposed by the carrier. For example, the cargo may leach, migrate, or otherwise move from the static carrier (e.g., a filter cake or coating of the carrier material). In such embodiments the carrier which transports and to some extent confines the cargo during and for some period after transport can be considered as a “cage” that entraps the cargo. Further, given the relative mobility of the cargo, the cargo can be envisioned broadly as a “snake” that is free to move about, within or around the confines imposed by the cage (i.e., carrier) during transport. Further, upon placement within the wellbore, the environmental conditions and/or conditions imposed during wellbore servicing may promote the mobility of the snake (i.e., cargo) to the extent that the snake may move outside the confines of the cage/carrier.

In an embodiment, the compositions and methods disclosed herein refer to materials (i.e., cargo/carrier complex) which are molecularly interspersed for at least a portion of the wellbore servicing operation. Thus, the carrier/cargo complexes of this disclosure exclude encapsulated materials. Materials which are encapsulated by deposition of chemicals that form less permeable membranes on the surfaces of active solid chemicals, for example an oxidative breaker used in oil field operations, for controlling the release of the active chemicals into a fluid medium, are not included in the current disclosure. In an embodiment, the carrier does not encapsulate the cargo. Furthermore, a method of controlling the release of chemicals into an external environment by pelletizing, under pressure, a solid physical blend of chemicals of which one solid is the active material, for example a drug, and the other is a solid that upon slow and gradual dissolution in the external fluid medium gradually exposes and releases the dispersed solid to the external medium is also excluded from the present disclosure. Unlike the present disclosure, neither in the encapsulation nor in the physical blending method for controlled release of materials is the active substance molecularly distributed in the carrier material. Instead, the active substance and carrier materials are interspersed in concentrated amounts or pure forms. Herein, the disclosure will further reference a carrier and cargo in the context of snake-in-cage compounds or compositions (SIC), provided however that such terms are non-limiting to the overall concept of carrier and cargo materials as described herein. In an embodiment, the snakes are mobile materials that can perform an intended function in a wellbore servicing operation. The release of such snakes into the wellbore can be controlled via the appropriate choice of cages as will be described in more detail herein. In an embodiment, the SIC comprises one or more materials which when introduced to a wellbore within a subterranean formation modifies the permeability of at least a portion of the formation in a manner that facilitates wellbore servicing operations. In some embodiments, the well servicing fluid (WSF) forms a filtercake on a surface of the formation wherein the SIC influences the permeability of the formation. In another embodiment, the WSF functions as a fracturing fluid wherein the SIC increases the permeability of at least a portion of the formation thus providing additional pathways for a resource (e.g., oil or gas) to flow into the wellbore. In some embodiments, the SIC serves the purpose of controlled release of active polymeric additives into the WSF or into the matrix permeability. SICs in general are described in Industrial Eng. Chem. (1957) volume 49, pages 1812-1819 which is incorporated by reference herein in its entirety.

In an embodiment, the SIC comprises a first component designated a “snake” and a second component designated a “cage” which when assembled form the “snake-in-cage” composition. Herein the cage refers to one or more materials which when assembled forms a structure with which the snake is associated. In some embodiments, the snake is disposed within the cage.

In an embodiment, the cage comprises any material which can be assembled to form a structure with which the snake is associated (e.g., disposed within) and is thermally stable. Herein “thermally stable” refers to temperature range in which the material resists chemical decomposition. The temperature may range from about 60° F. to about 500° F., alternatively from about 120° F. to about 400° F., or alternatively from about 180° F. to about 350° F. Cages suitable for use in this disclosure may comprise organic polymers, inorganic materials, or combinations thereof. In an embodiment, the cage is a hydrogel. A hydrogel is defined as a gel containing water as the dispersion medium in which either a cross-linked or uncrosslinked network of hydrophilic polymer or colloidal particles are dispersed that bind and immobilize water molecules.

In an embodiment, the cage comprises an organic polymer. Organic polymers suitable for use as cages in this disclosure include without limitation water-swellable polymers, water-soluble polymers, or acrylic acid-based polymers, and combinations thereof.

In an embodiment, the cage comprises a water-swellable polymer. Nonlimiting examples of water-swellable polymers suitable for use in this disclosure include pre-crosslinked polymers, such as starch, polyacrylamide, polymethacrylate, or combinations thereof. In an embodiment such polymers are dry or substantially free of a liquid component.

In an embodiment, the water-swellable polymer is a superabsorbent. Examples of superabsorbents include sodium (alkyl)acrylate-based polymers having three dimensional, network-like molecular structures. The polymer chains are formed by the reaction/joining of millions of identical units of acrylic acid monomer, which have been substantially neutralized with sodium hydroxide (caustic soda). Crosslinking chemicals tie the chains together to form a three-dimensional network, enabling the superabsorbents to absorb water or water-based solutions into the spaces in the molecular network, and thus forming a gel and locking up the liquid.

Other examples of water-swellable polymers suitable for use in this disclosure include MAXSEAL fluid loss control additive and CRYSTALSEAL service which are based on hydroxyethylcellulose and polyacrylate respectively and are commercially available from Halliburton Energy Services.

In an embodiment, the cage comprises a hydrogel comprised of water-soluble biopolymers and crosslinkers. For example, the cage may comprise hydrogels comprising polysaccharides or polysaccharide derivatives such as hydroxyl ethyl, hydroxypropyl, carboxymethyl, carboxymethyl hydroxylethyl, and grafted polymers such as 2-acrylamido-2-methyl-propane sulfonic grafted, acrylonitrile grafted, acrylamide grafted, acrylic acid grafted, vinyl phosphonic acid grafted or vinyl sulfonic acid grafted polymers. Examples of suitable polysaccharides include without limitation alginic acid and its salts, pectinates, chitosan and guar. Inorganic materials suitable as crosslinkers for forming hydrogels for use in the present disclosure include without limitation borate salts, phosphoryl chloride, main group or transition metal salts such Group 2 and Group 13 main group metal salts and Group 4, 6 and Group 8 transition metal salts, or combinations thereof. Suitable organic crosslinkers include 3-chloropropylene oxide (epichlorohydrin), genepin, glyoxal, glutaraldehyde and dichlorodialkylsilanes.

In an embodiment, the cage comprises hydrogels derived from acrylic acid-based polymers or derivatives thereof and crosslinkers. Nonlimiting examples of acrylic-acid based polymers or derivatives thereof suitable for use in this disclosure include methacrylic acid-based polymers, acrylic acid-based polymers, acrylamide-based polymers, or combinations thereof. Suitable crosslinkers include polyethyleneimines, polyvinylamines, and transition metal and main group metal based salts of the type disclosed herein.

In an embodiment, the cage comprises hydrogels derived from acrylic acid-based monomers, polymerization initiators and crosslinkers. Examples of acrylic acid based monomers suitable for use in formation of the hydrogel include without limitation hydroxyethylacrylate, acrylic acid and its alkali and alkaline earth metal salts, methacrylic acid and its alkali and alkaline earth metal salts, acrylamide and N,N-dimethylaminoethyl methacrylate, N-hydroxymethyl acrylamide. Examples of polymerization initiators suitable for use in formation of the hydrogel include without limitation water soluble azo-initiators, sodium persulfate, and redox initiators. Crosslinkers suitable for use in the preparation of the hydrogel include without limitation methylene bisacrylamide, ethylene glycol bis-acrylate and main group and transition metal salts of the type disclosed herein. In an embodiment the hydrogel is PERMSEAL system which is a chemical sealant commercially available from Halliburton Energy Services.

In an embodiment, the cage comprises an inorganic material. In an embodiment the cage comprises silicon tetraoxide (i.e., SiO₄) structural units. In another embodiment the cage comprises a non-hydraulic cement.

In an embodiment, the cage comprising SiO₄ structural units is derived from a sol-gel process. Herein a sol-gel process refers to a method of fabricating materials starting from a solution form (sol) that acts as the precursor for an integrated network (or gel) of either discrete particles or network polymers. An example of a cage (i.e., carrier) comprising SiO₄ structure prepared by the sol-gel process includes without limitation gels formed from the polymerization of tetraalkoxy silanes, such as tetramethoxy (TMOS) or tetraethoxy (TEOS) silanes, which in the presence of water and catalysts, hydrolyze and undergo condensation polymerization to form gels containing one-dimensional, two-dimensional and three dimensional polymer networks as the solid phase mixed with liquid phase containing water and colloidal particles. A second method suitable for building cages comprising SiO₄ structural units by the sol-gel process involves gelling colloidal silica using a salt solution. The colloidal silica may have nanosized silica particles stabilized in an aqueous or water-miscible fluid (e.g., alcohol). Stabilization of the nanosized silica particles may be accomplished using any suitable methodology for example by electrostatic repulsions with high pH or steric repulsions or by addition of adsorbing polymers. An example of a nanosilica sol that is suitable for use in the present disclosure is GASCON 469 cement additive which is a liquid cement additive commercially available from Halliburton Energy Services. An example of a sol-gel that is obtainable from a colloidal silica solution using salt solutions is FORMSEAL which is commercially available from Halliburton. A third system suitable for building cages comprising SiO₄ structural units is gelling sodium silicate solutions by suitably adjusting pH. Sodium silicate solutions, also called soda glass solutions are water soluble reaction products of silica and sodium oxide. When such solutions are subjected pH change, either in the acidic range with a pH in 1-3 range or in the neutral to slightly basic pH range, for example 7-9, the solutions form stiff transparent gels. The pH of the fluids can be changed by addition of pH control agents such as organic esters, urea, lactose or sodium polyphosphate. Such gellable fluid systems are available as INJECTROL sealant which is a silicate system commercially available from Halliburton Energy Services.

In an embodiment, the inorganic cage comprises a non-hydraulic cementiceous material. Cage systems comprising non-hydraulic cementiceous materials based inorganic systems comprise cementiceous materials which set upon reaction with water, but the set cementiceous products dissolve or disintegrate over time with continued exposure to water. They remain hard as long as they are kept dry. Examples of non-hydraulic cements suitable for use in the present disclosure include without limitation calcium sulfate cements, and Sorel cements based on magnesium oxide and magnesium chloride. The latter are also referred to as oxychloride cements. In an embodiment, the non-hydraulic cement is acid soluble, An example of acid soluble non-hydraulic cement is Sorel cement based magnesium oxide and magnesium chloride available as THERMATEK rigid setting fluid which is commercially available from Halliburton Energy Services.

In an embodiment, the cage comprises a mixture of an organic polymer and an inorganic material, herein termed a “mixture.” For example, the cage may comprise a mixture of an organic polymer and an inorganic clay. Alternatively, the cage may comprise a mixture of an organic polymer and a cement. Alternately, the cage may comprise a SiO₄ structural unit that is incorporated into an organic siloxane polymer. The cage is said to be formed from the mixture which when contacted generates a material (e.g., gel, solid mass, viscous mass) with which a snake can be associated.

In an embodiment, the cage comprises a mixture of a water-soluble polymer and an inorganic clay. The water-soluble polymer may be any water-soluble polymer compatible with the other components of the SIC. In an embodiment, the water-soluble polymer is of the type described previously herein. The inorganic clay may be any clay compatible with the other components of the SIC. Clays suitable for use in this disclosure include without limitation are layered phyllosilicates. Suitable clays may include swellable and non-swellable clays. An example of a synthetic swellable clay is laponite. Natural clays which are swellable belong to the general class of smectite clays. Specific examples of smectite clays include monmorillonite (bentonite), hectorite and saponite. Examples of layered non-swellabe clays include kaolinite and halloysite. In an embodiment, the clay particles are nano sized particles with particle sizes less than 300 nm. In an embodiment the cage is formed when the water-soluble polymer and an inorganic clay are mixed under conditions suitable for the formation of a hydrogel or a hydratable composite material. For example the clay may be dispersed in water, and allowed to deagglomerate and partially or fully exfoliate, then the water-soluble polymer may be added to the clay suspension. In other methods, solid composites may be directly prepared by blending clay, a clay expanding agent that serves to expand the interlayer distance and a polymer or by polymerizing monomers that are preadsorbed in the interlayer spacing of the clay to form a water soluble, hydrophilic polymer.

In an embodiment, the dry composites when added to an aqueous fluid form hydrogels that swell and/or provide viscosified fluids. The weight % clay by weight of polymer will depend on the polymer, clay type and particle sizes and the method of preparation. In some embodiments the water-soluble polymer may be present in an amount of from about 50% to about 99%, alternatively from about 60% to about 90%, or alternatively from about 70% to about 90% while the inorganic clay may be present in an amount of from about 1% to about 50%, alternatively from about 3% to about 30% or alternatively from about 5% to about 10% of combined weight of the polymer and clay.

In an embodiment, the cage comprises a mixture of a water-soluble polymer and a non-hydraulic cement. The water-soluble polymer may be any water-soluble polymer compatible with the other components of the SIC. In an embodiment, the water-soluble polymer is of the type described previously herein. The cement may be any non-hydraulic cement of the type previously described herein. The cage may be formed by contacting the water-soluble polymer, non-hydraulic cement and required amount of water. In an embodiment the non-hydraulic cement is magnesium oxychloride cement. In an embodiment, the non-hydraulic cement comprises, calcium sulfate (anhydrite), calcium sulfate hemihydrate (Plaster of Paris). In an embodiment, the non-hydraulic cement may be naturally acid-soluble. In an embodiment the non-hydraulic cage composition comprises an acid soluble additive, for example calcium carbonate. In an embodiment, where the cage is formed from a mixture of a water-soluble polymer and a non-hydraulic cement the water-soluble polymer may be present in an amount of from about 0.5 weight percent (wt. %) to about 20 wt. %, alternatively from about 1 wt. % to about 10 wt. %, or alternatively from about 3 wt. % to about 8 wt. % by weight of the set non-hydraulic cement composition.

In an embodiment, the cage may comprise a SiO₄ structural unit that is incorporated into an organic siloxane polymer. A siloxane polymer suitable for use in the present disclosure may be prepared by any suitable methodology. In an embodiment the siloxane polymer is prepared by the condensative polymerization of a dialkylsiloxane and a siloxane crosslinker as depicted in Scheme I. Referring to Scheme I a diakylsiloxane is polymerized in the presence of a tetraalkylsiloxane crosslinking group to from a crosslinked siloxane polymer.

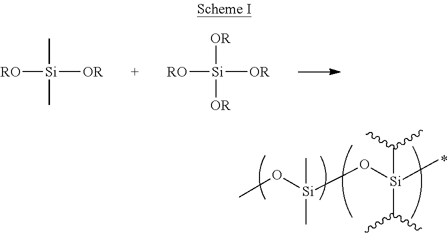

In an embodiment, a dialkylsiloxane suitable for use in the present disclosure is characterized by general Formula I where R₁ is a C₁-C₄ alkyl unit and the siloxane crosslinker is a tetraalkylsilane characterized by general Formula II wherein R₂ is methyl or ethyl group.

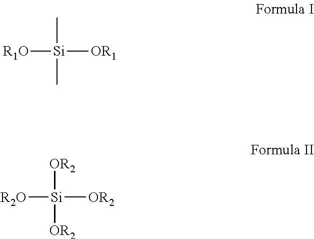

In an embodiment, the crosslinker is sodium silicate. In an embodiment, the dialkylsiloxane may be replaced by a siloxane comprising ethylenically unsaturated groups. Hydrogels based on such compositions are described in more detail in U.S. Pat. No. 7,906,563 which is incorporated by reference herein in its entirety.

In an embodiment, the SIC comprises a snake. A snake may be characterized as a polymeric material with the ability to be associated with a cage material of the type disclosed herein. The snake may be further characterized as being labile with respect to the cage. In some embodiments, the snake is disposed within the cage material such that the snake's mobility is obstructed to some extent by the structure formed by the cage. In an embodiment, the snake is reversibly associated with the cage such that external stimuli will allow for the snake to become disassociated with the cage. In an embodiment, the snake may be incorporated into the cage in a pre-crosslinked form containing degradable crosslinks. Such materials may hydrate in an aqueous media, and become molecularly dispersed in the cage, but with limited mobility. The snake may become disassociated with the cage as a function of a variety of factors such as time, temperature, and/or pH. It is to be understood that such conditions may function to increase the mobility of the snake such that the snake is able to migrate outside of the confines of the cage. Alternatively the conditions may impact the integrity of the cage to some extent that the cage no longer provides a sufficient obstruction to the mobility of the snake. In an embodiment, the snake may comprise a material which when dissociated from the cage provides one or more user and/or process desired functionalities. Nonlimiting examples of snakes suitable for use in this disclosure include fluid loss agents, relative permeability modifiers, viscosity modifiers, clean-up additives, scale prevention additives, differential pressure controlling additives, or combinations thereof.

In an embodiment, the snake comprises a fluid loss additive. Fluid loss additives herein refer to chemical additives used to control the loss of a fluid to the formation through filtration. Further, the fluid loss additive may function to retain proper liquid levels within a wellbore servicing fluid thus ensuring the integrity of the fluid design parameters. Fluid loss additives suitable for use in the present disclosure include hydrophobically modified water soluble polymers, crosslinked polyacrylamide; crosslinked polyacrylate; crosslinked hydrolyzed polyacrylamide; salts of carboxyalkyl starch, for example, salts of carboxymethyl starch; salts of carboxyalkyl cellulose, for example, salts of carboxymethyl cellulose; salts of any crosslinked carboxyalkyl polysaccharide; crosslinked copolymers of acrylamide and acrylate monomers; starch grafted with acrylonitrile and acrylate monomers; copolymers comprising two or more of allylsulfonate, 2-acrylamido-2-methyl-1-propanesulfonic acid, 3-allyloxy-2-hydroxy-1-propane-sulfonic acid, acrylamide, and acrylic acid monomers; or combinations thereof. In an embodiment, the polymeric snake material is not crosslinked. In an embodiment, the snake comprises hydrophobically modified polydimethylaminoethyl methacrylate polymers such as those described in U.S. Pat. No. 7,117,942 which is incorporated by reference herein in its entirety.

In an embodiment, the snake comprises a relative permeability modifier (RPM). RPMs herein refer to materials used to reduce a completed interval's effective permeability to water while minimally impacting the interval's effective permeability to oil and/or gas. In an embodiment the RPM comprises a homopolymer or a random copolymer. Examples of such polymers are described in U.S. Pat. Nos. 6,364,016; 6,476,169 and 7,182,136 each of which is incorporated herein in its entirety. Alternatively, the RPM comprises a synthetic vinyl polymer, a naturally-occurring polymer, or combinations thereof. In an embodiment, the RPM comprises polyacrylamide, hydrolyzed polyacrylamide, a hydrophobically modified water soluble polymer or combinations thereof.

In an embodiment, the snake comprises a viscosity modifier. A viscosity modifier herein refers to any material that functions to adjust the viscosity of a composition to a user and/or process desired range. In an embodiment, the viscosity modifier comprises biopolymers, for example polysaccharides and their derivatives, and synthetic polymers for example polyethylene oxides and polyacrylamides.

In an embodiment, the snake comprises a clean-up additive. Herein clean-up additives refer to materials used for the removal of oil-based and/or synthetic drilling fluid residue from the work string and wellbore. Nonlimiting examples of clean-up additives suitable for use in the present disclosure include water-wetting polymers such as those described in U.S. Pat. No. 6,846,420 which is incorporated herein in its entirety.

In an embodiment, the snake comprises a scale prevention additive (SPA). Herein scale refers to an assemblage of deposits that form in wellbore servicing areas and equipment such as perforations, casing, production tubing, valves, pumps, and downhole completion equipment thereby clogging and/or obstructing the wellbore and/or associated equipment and inhibiting fluid flow. Nonlimiting examples of SPAs suitable for use in the present disclosure include polyacrylates and polyaspartic acid salts.

In an embodiment, the snake may be further characterized by its ability to resist degradation at temperatures greater than about 400° F. In some embodiments, a snake having an improved resistance to degradation at temperatures greater than about 400° F. may be prepared using standard polymerization techniques. For example, the snake may comprise any combination of monomers selected from acrylic acid, N,N-dimethylacrylamide, N,N-Diethylacrylamide, 2-acrylamide-2-methylpropane sulfonic acid and its salts, allyl sulfonic acid and its salts, vinylpyrrolidone, vinyl sulfonic acid and its salts, or allylbenzene sulfonic acid and its salts.

In an embodiment, the snake and cage are each present in WSF in amounts effective to perform its intended function. Thus, the amount of snake may range from about 1 wt. % to about 20 wt. %, alternatively from about 2 wt. % to about 10 wt. % or alternatively from about 3 wt. % to about 8 wt. % by weight based on the weight of the WSF fluid while the amount of cage may range from about 0.1 wt. % to about 5 wt. %, alternatively from about 1 wt. % to about 4 wt. % or alternatively from about 2 wt. % to about 3 wt. % by weight based on the total weight of WSF.

In an embodiment, a snake of the type disclosed herein is associated with a cage of the type disclosed herein using any suitable methodology.

In an embodiment, the cage comprises a preformed material such as for example a pre-crosslinked water-swellable polymer of the type previously described herein. In such embodiments, the snake-in-cage composition may be formed by impregnation of the cage with a composition comprising the snake under conditions suitable for association of the snake with the cage. For example, the pre-crosslinked water-swellable polymer may be swollen in a solution containing the snake such that the snake becomes associated with or disposed within the swollen polymer (i.e., cage).

In an embodiment, the SIC is in the form of solid comprising inorganic cage. In such embodiments, non-hydraulic cement may be mixed with water containing the snake material, and the cement allowed to set. Additive to aid in the setting of cement and to modify the set cement properties may be added to the composition during the mixing phase. The set cement may be ground or pulverized to desired particle sizes and used as SIC in the WSF. In an embodiment, the cage comprises a dual-gel system of the type described herein and the snake comprises an organic polymer. In such an embodiment, a portion of the cage is formed in the presence of the snake by treatment of the cage forming materials with water under the appropriate conditions. The remainder of the cage may be formed downhole based on the conditions of the wellbore.

In an embodiment the cage comprises a first polymer and the snake comprises a second polymer. In an embodiment, the cage is formed in the presence of the snake using a crosslinker selective for the first polymer. For example the cage may be formed by the first polymer comprising alginate polymer in the presence of a crosslinker comprising calcium chloride solution and a snake comprising Polyethylene oxide. In an embodiment, the cage comprises fracturing fluids that employ polymers which are crosslinkable polymers, crosslinkers and a non-crosslinking polymer such as starch or modified cellulose. Such fracturing fluid systems are available as SCIRROCO fracturing service or DEEPQUEST service from Halliburton Energy Services. SCIRROCO fracturing service is a fracturing fluid system and DEEPQUEST service is a weighted simulation fluid system both of which are commercially available from Halliburton Energy Services.

In an embodiment the cage comprises a water-swellable uncrosslinked polymer, for example waxy maize starch, which is first swollen in an aqueous solution to form a swollen polymer. The swollen polymer may then be crosslinked in the presence of a snake to form a snake-in-cage composition using a crosslinker, for example phosphoryl chloride.

In an embodiment, additives for improving mechanical properties of the cage structure in an SIC of the type disclosed herein may be added to the composition during the preparation of the SIC composition. Suitable additives for improving cage mechanical properties include elastomer particles, fibers such as glass fibers, carbon fibers, metal fibers and mineral fibers, flaky minerals such as mica, and irregular shaped minerals such as ferric oxide, barite, Portland cement particles, and solid polymer additives such as polylactic acid, polyglycolate and combinations thereof.

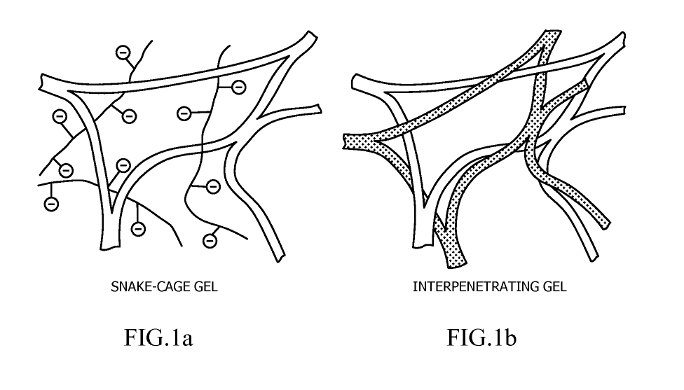

Without wishing to be limited by theory, snake-in-cages formed from systems described herein having two polymers may form semi-interpenetrating polymer. Graphical representations of interpenetrating networks are presented in FIGS. 1a and 1b. FIG. 1a depicts a SIC of the type disclosed herein where the snake is an uncosslinked mobile polymer (represented by the thinner lines with branching) that may initially be associated with the cage (i.e., the crosslinked polymer represented by the thicker solid lines) which while initially entangled could disassociate from the cage. In contrast an interpenetrating network of polymers, as depicted in FIG. 1b, has two distinct, fully crosslinked and entwined materials which are unable to dissociate from each other without the breaking of a covalent bond.

In an embodiment, the SIC is used as a fluid loss control additive and is present in the wellbore servicing fluid in an amount of from about 1 wt. % to about 20 wt. %, alternatively from about 2 wt. % to about 15 wt. %, or alternatively from about 5 wt. % to about 10 wt. % by total weight of the WSF. In an embodiment, the wellbore servicing fluid is a fracturing fluid and the SIC is present in an amount of from about 1 wt. % to about 10 wt. %, alternatively from about 2 wt. % to about 8 wt. %, or alternatively from about 3 wt. % to about 5 wt. % by weight of the WSF.

A SIC of the type disclosed herein may be included in any suitable wellbore servicing fluid. As used herein, a “servicing fluid” refers to a fluid used to drill, complete, work over, fracture, repair, or in any way prepare a wellbore for the recovery of materials residing in a subterranean formation penetrated by the wellbore. Examples of wellbore servicing fluids include, but are not limited to, cement slurries, drilling fluids or muds, spacer fluids, fracturing fluids or completion fluids. The servicing fluid is for use in a wellbore that penetrates a subterranean formation. It is to be understood that “subterranean formation” encompasses both areas below exposed earth and areas below earth covered by water such as ocean or fresh water.

In an embodiment, a method of servicing a wellbore comprises including a SIC of the type disclosed herein in a wellbore servicing fluid and placing the wellbore servicing fluid into a wellbore. There the cage component of the SIC may form a filtercake on the face of the formation. In some embodiments, the formation may have a conventional filtercake in addition to a filtercake formed from the cage component of the SIC. In an embodiment, the snake component of the SIC enters the formation to an extent sufficient to perform the intended function of the snake.

In an embodiment, the method of servicing the wellbore further comprises removal of the filtercake formed from the cage component of the SIC. As will be understood by one of ordinary skill in the art, the method for removal of the filtercake formed from the cage component of the SIC will depend on the chemical composition of the cage component. In some embodiments, the cage comprises a material that degrades over some time period upon exposure to typical wellbore conditions (e.g. temperature, pH, etc.).

In an embodiment, the cage comprises a water-swollen organic polymer. In such embodiments the filtercake comprising the cage may be removed by shrinking the water-swollen organic polymer in the presence of a brine. Brines are aqueous fluids that are typically saturated or nearly saturated with salt. Examples of brines suitable for use in this disclosure include without limitation saturated or partially saturated aqueous solutions comprising halide-containing salts, alkali metal salts, alkaline metal salts, formate-containing compounds, sodium bromide (NaBr), calcium chloride (CaCl₂), calcium bromide (CaBr₂), sodium chloride (NaCl), zinc bromide (ZnBr₂), sodium formate, cesium formate, potassium formate, derivatives thereof, or combinations thereof.

In an embodiment, a filtercake comprising the cage component may be removed through the use of a filtercake removal agent (FRA) such as acids or acidic compounds, breakers, or oxidizers. Any FRA compatible with the wellbore servicing operation may be suitably employed to remove the filtercake comprising the cage component. In an embodiment, the cage material further comprises a FRA in a delayed-release form. For example, the FRA may be encapsulated within a material that degrades over time such that the FRA is released and contacted with the cage material after some user and/or process desired time period. In an alternative embodiment, the FRA is in a precursor form such that under certain conditions (e.g., time, temperature) an FRA having the ability to degrade the filtercake is generated.

In an embodiment, the precursor FRA comprises an acid precursor. Herein an acid precursor is defined as a material or combination of materials that provides for delayed release of one or more acidic species. Such acid precursors may also be referred to as time-delayed and/or time-released acids. In embodiments, acid precursors comprise a material or combination of materials that may react to generate and/or liberate an acid after a period of time has elapsed. The liberation of the acidic species from the acid precursor may be accomplished through any means known to one of ordinary skill in the art with the benefits of this disclosure and compatible with the user-desired applications. In embodiments, acid precursors may be formed by modifying acids via the addition of an operable functionality component or substituent, physical encapsulation or packaging, or combinations thereof. The operable functionality component or substituent may be acted upon in any fashion (e.g., chemically, physically, thermally, etc.) and under any conditions compatible with the components of the process in order to release the acid at a desired time and/or under desired conditions such as in situ wellbore conditions. In an embodiment, the acid precursor may comprise at least one modified acid (e.g., having an operable functionality, encapsulation, packaging, etc.) such that when acted upon and/or in response to pre-defined conditions (e.g., in situ wellbore conditions such as temperature, pressure, chemical environment), an acid is released. In an embodiment, the acid precursor may comprise an acidic species that is released after exposure to an elevated temperature such as an elevated wellbore temperature. In an embodiment, the acid precursor compound comprises a reactive ester. For simplicity, the remainder of the disclosure will focus on the use of a reactive ester as the acid precursor with the understanding that other acid precursors may be used in various embodiments. The reactive ester may be converted to an acidic species by hydrolysis of the ester linkage, for example by contact with water present in situ in the wellbore. Suitable acid precursors for use in the present disclosure include lactic acid derivatives such as methyl lactate, ethyl lactate, propyl lactate, butyl lactate; esters and/or formates that are water soluble or partially soluble such as ethylene glycol monoformate, methyl formate, ethyl formate, methyl chloro formate, triethyl orthoformate, trimethyl orthoformate, ethylene glycol diformate, diethylene glycol diformate, glyceryl monoformate, glyceryl diformate, glyceryl triformate, triethylene glycol diformate; formate esters of pentaerythritol; esters or polyesters of glycerol including, but not limited to, tripropionin (a triester of propionic acid and glycerol), trilactin, esters of acetic acid and glycerol such as monoacetin, diacetin, and triacetin; esters of glycolic acid such as ethyl or methyl or propyl or butyl glycolate or esters of glycolic acid and polyols such as glycerol and glycols, aliphatic polyesters; poly(lactides); poly(glycolides); poly(c-caprolactones); poly(hydroxybutyrates); poly(anhydrides); aliphatic polycarbonates; poly(amino acids); and polyphosphazenes; or copolymers thereof: poly(ortho esters); orthoesters (which may also be known as “poly ortho ethers” or “ortho ethers”); esters of oxalic acid; aliphatic polyesters; poly(lactides); poly(glycolides); poly(c-caprolactones); poly(hydroxybutyrates); poly(anhydrides); poly(amino acids); esters of propionic acid; esters of butyric acid; esters of monochloroacetic acid; esters of dichloroacetic acid; esters of trichloroacetic acid; derivatives thereof; or combinations thereof. Other suitable acid precursors include halide esters and esters of acids such as esters of nitric acid, sulphuric acid, sulphonic acid, sulphinic acid, phosphoric acid, phosphorous acid, phosphonic acid, phosphinic acid, sulphamic acid and the like. In an embodiment, the FRA comprises an oxidizer such as magnesium peroxide.

SIC compositions of the type disclosed herein may advantageously provide delayed release of one or more wellbore servicing materials over a broad temperature range. For example SIC compositions may advantageously provide a beneficial activity of the type disclosed herein (e.g., fluid loss, clean-up) at a temperature of greater than about 300° F., alternatively greater than about 350 F. or alternatively from about 400 F. Further, SICs of the type disclosed herein may advantageously decrease the permeability of the wellbore so as to mitigate the unwanted loss of fluids into the formation to which it is introduced without negatively impacting the conductivity of the wellbore in terms of the ability of the wellbore to transport a resource such as oil and/or gas.

### Additional Disclosure

The following are nonlimiting, specific embodiments in accordance with the present disclosure:

A first embodiment, which is a method of servicing a wellbore in a subterranean formation comprising:

preparing a wellbore servicing fluid comprising a snake-in-cage composition; and

placing the wellbore servicing fluid into a wellbore wherein the snake dissociates from the cage and enters one or more permeable zones within the wellbore.

A second embodiment, which is the method of the first embodiment wherein the cage comprises an organic polymer, an inorganic material, or an inorganic-organic mixture.

A third embodiment, which is the method of the second embodiment wherein the organic polymer comprises a water-swellable polymer, water-soluble polymer, an acrylic-based polymer, or combinations thereof.

A fourth embodiment, which is the method of the second embodiment wherein the inorganic material comprises an inorganic polymer, an acid-soluble cement, or combinations thereof.

A fifth embodiment, which is the method of the second or fourth embodiment wherein the inorganic polymer comprises a SiO₄ structural unit

A sixth embodiment, which is the method of the fourth embodiment wherein the acid soluble cement comprises a magnesium-based or a calcium-based non-hydraulic cement, or both.

A seventh embodiment, which is the method of the sixth embodiment wherein the magnesium-based cement comprises magnesium oxychloride.

An eighth embodiment, which is the method of any of the first through seventh embodiments wherein the cage comprises a mixture of an organic polymer and an inorganic material.

A ninth embodiment, which is the method of any of the first through eighth embodiments wherein the cage comprises a polymer and a clay.

A tenth embodiment, which is the method of the ninth embodiment wherein the clay comprises laponite.

An eleventh embodiment, which is the method of any of the first through tenth embodiments wherein the snake comprises a fluid loss additive, a relative permeability modifier, a viscosity modifier, a clean-up additive, a scale prevention additive, or combinations thereof.

A twelfth embodiment, which is the method of any of the first through eleventh embodiments wherein the snake is present in the wellbore servicing fluid in an amount of from about 1 wt. % to about 20 wt. %.

A thirteenth embodiment, which is the method of any of the first through twelfth embodiments wherein the cage is present in the wellbore servicing fluid in an amount of from about 0.1 wt. % to about 5 wt. %.

A fourteenth embodiment, which is the method of any of the first through thirteenth embodiments wherein the subterranean formation has a temperature of greater than about 300° F.

A fifteenth embodiment, which is the method of any of the first through fourteenth embodiments wherein the cage forms a filtercake on a face of the subterranean formation.

A sixteenth embodiment, which is the method of any of the first through fifteenth embodiments further comprising removing the filtercake.

A seventeenth embodiment, which is the method of any of the first through sixteenth embodiments wherein removing the filtercake comprises contacting the filtercake with a brine, an acid, a breaker, an oxidizer, an acid-precursor, or combinations thereof.

An eighteenth embodiment, which is the method of any of the first through seventeenth embodiments wherein the wellbore servicing fluid comprises a fracturing fluid, a fluid loss additive, a stimulation fluid, or combinations thereof.

A nineteenth embodiment, which is a wellbore treatment composition comprising:

a snake disposed within a cage wherein the cage comprises a crosslinked polymer.

A twentieth embodiment, which is the composition of the nineteenth embodiment wherein the crosslinked polymer comprises siloxanes, an acrylamide-containing polymer, a water-soluble polymer, a water-swellable polymer, or combinations thereof.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}-R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of servicing a wellbore in a subterranean formation comprising;
preparing a wellbore servicing fluid comprising a snake-in-cage composition; and
placing the wellbore servicing fluid into a wellbore wherein the snake dissociates from the cage and enters one or more permeable zones within the wellbore.

2. The method of claim 1 wherein the cage comprises an organic polymer, an inorganic material, or an inorganic-organic mixture.

3. The method of claim 1 wherein the organic polymer comprises a water-swellable polymer, water-soluble polymer, an acrylic-based polymer, or combinations thereof.

4. The method of claim 1 wherein the inorganic material comprises an inorganic polymer, an acid-soluble cement, or combinations thereof.

5. The method of claim 4 wherein the inorganic polymer comprises a SiO₄ structural unit

6. The method of claim 4 wherein the acid soluble cement comprises a magnesium-based or a calcium-based non-hydraulic cement, or both.

7. The method of claim 6 wherein the magnesium-based cement comprises comprises magnesium oxychloride.

8. The method of claim 1 wherein the cage comprises a mixture of an organic polymer and an inorganic material.

9. The method of claim 8 wherein the cage comprises a polymer and a clay.

10. The method of claim 9 wherein the clay comprises laponite.

11. The method of claim 1 wherein the snake comprises a fluid loss additive, a relative permeability modifier, a viscosity modifier, a clean-up additive, a scale prevention additive, or combinations thereof.

12. The method of claim 1 wherein the snake is present in the wellbore servicing fluid in an amount of from about 1 wt. % to about 20 wt. %.

13. The method of claim 1 wherein the cage is present in the wellbore servicing fluid in an amount of from about 0.1 wt. % to about 5 wt. %.

14. The method of claim 1 wherein the subterranean formation has a temperature of greater than about 300° F.

15. The method of claim 1 wherein the cage forms a filtercake on a face of the subterranean formation.

16. The method of claim 15 further comprising removing the filtercake.

17. The method of claim 16 wherein removing the filtercake comprises contacting the filtercake with a brine, an acid, a breaker, an oxidizer, an acid-precursor, or combinations thereof.

18. The method of claim 1 wherein the wellbore servicing fluid comprises a fracturing fluid, a fluid loss additive, a stimulation fluid, or combinations thereof.

19. A wellbore treatment composition comprising:
a snake disposed within a cage wherein the cage comprises a crosslinked polymer.

20. The composition of claim 19 wherein the crosslinked polymer comprises siloxanes, an acrylamide-containing polymer, a water-soluble polymer, a water-swellable polymer, or combinations thereof.
